(19) United States
(12) Patent Application Publication
(10) Pub. No.: US 2018/0222036 A1
(43) Pub. Date: Aug. 9, 2018

(54) DISASSEMBLABLE CHAIR

(71) Applicant: Kurt Widmer, Hernando Beach, FL (US)

(72) Inventor: Kurt Widmer, Hernando Beach, FL (US)

(21) Appl. No.: 15/283,362

(22) Filed: Oct. 1, 2016

(51) Int. Cl. B25H 5/00; A47C 4/02; A47C 5/04; A47C 7/00; A47C 7/42

(52) U.S. Cl. CPC B25H 5/00; A47C 4/02; A47C 7/42; A47C 7/006; A47C 5/04

(57) ABSTRACT

A chair chassis for constructing a disassemblable chair includes a seat member and a backrest member. The seat member is configured to provide a seat, where a rear section of the seat member comprises a first engagement member, and the backrest member comprises a second engagement member, where the second engagement member is engaged to the first engagement member of the seat member to removably connect the backrest member to the seat member, where the backrest member is selectively removable from the seat member.

### BACKGROUND

Convertible creeper chairs or assemblies are popular in the automobile mechanics sector, where such convertible creepers are used to provide support and comfort for a person in a lied down position or in a seated erect position while performing work, for example, the work of an auto mechanic on an automobile or some other similar equipment. The convertible creeper chair, also known as a mechanic's creeper, is a seating device generally used to support a mechanic in a lying position and at a minimal height above the ground level to enable work in the underside of a vehicle. A general creeper assembly comprises a framework having a normally flat support section. The framework is typically supported on wheels, for example, castor wheels, to allow the person, who is supported in the lying down position, to displace the creeper assembly framework from one position to another position below the vehicle, where it is difficult to reach during a normal working procedure.

Convertible creeper units are also identified to be modifiable between various positions, for example, a lowered lying configuration and a raised seated configuration. Anyhow, known convertible creeper units are constructed to be manually adjusted between the lowered lying configuration and the raised seated configuration when a person is not supported on the creeper unit. Therefore, these creeper units can prove to be inconvenient to adjust between the various configurations. However, such conventional creeper units face some problems, such as, during a normal working procedure, when the mechanic wants to sit or lie down in a certain configuration where the backrest has to be avoided from interfering with work, the mechanic finds it very difficult to work because of the hindrance caused by the backrest. Therefore, the mechanic is forced to adjust the backrest in a position which is inconvenient and he/she has to choose a feasible method to get the work done, which might not be efficient and might be time consuming. Further, most conventional creeper units, in their seating position, are always about 15 to 16 inches above the ground which makes it difficult for a mechanic, if he wants to be seated in the ground level itself. Therefore, there is a need for a creeper assembly framework that can be disassembled to enable a singular seating position for the mechanic or user in close contact with the ground level.

Hence, there is a long felt but unresolved need for a chair chassis for constructing a disassemblable chair, where the seating section and the backrest section can be removably attached to enable the user to sit or lie down without the hindrance from the backrest, and to enable the user to sit down at the ground level itself and perform the work.

### SUMMARY OF THE INVENTION

The chair chassis for constructing a disassemblable chair disclosed herein addresses the above mentioned need for a creeper assembly where the seating section and the backrest section can be removably attached to enable the user to sit or lie down without the hindrance from the backrest, and to enable the user to sit down at the ground level itself and perform the work. The chair chassis for constructing a disassemblable chair comprises a seat member and a backrest member. The seat member is configured to provide a seat, where a rear section of the seat member comprises a first engagement member, and the backrest member comprises a second engagement member, where the second engagement member is engaged to the first engagement member of the seat member to removably connect the backrest member to the seat member, where the backrest member is selectively removable from the seat member.

In an embodiment, the backrest member is engaged to a first of the first engagement members of the seat member, where the seat member and the backrest member are in a substantially horizontal position. In an embodiment, the backrest member is engaged to a second of the first engagement members of the seat member, wherein the seat member and the backrest member are in a substantially angled position. In an embodiment, the seat member and the backrest member are defined by a tubular framework. In an embodiment, the tubular framework defining the seat member and the backrest member comprises a generally U shaped tube member with cross bars extending across angled afts of the U shaped tube member.

In an embodiment, the first engagement member is a set of female connectors, and the second engagement member is a set of male connectors, where both the male connectors and the female connectors are positioned on the angled afts of the U shaped tube members defining the framework of the seat member and the backrest member. In an embodiment, each male connector is inserted into the female connector to form a sliding fit connection between the seat member and the backrest member. In an embodiment, the angled afts of the seat member and the backrest member comprise openings positioned proximal to the distal ends of the seat member and the backrest member, where the openings are configured to receive and attach castor wheels. In an embodiment, the angled afts of the seat member and the backrest member comprise holes positioned on predefined points, wherein the holes are configured to receive fasteners of cushion members which are configured to be attached on the tubular framework of the seat member and the backrest member.

### BRIEF DESCRIPTION OF THE DRAWINGS

FIG. 1A exemplarily illustrates a top plan view of a chair chassis for a disassemblable chair.

FIG. 1B exemplarily illustrates a top perspective view of a chair chassis for a disassemblable chair, showing the horizontal orientation of the seat member and the backrest member.

FIG. 2 exemplarily illustrates a top perspective view of a chair chassis for a disassemblable chair, showing angled orientation of the seat member and the backrest member.

### DETAILED DESCRIPTION OF THE INVENTION

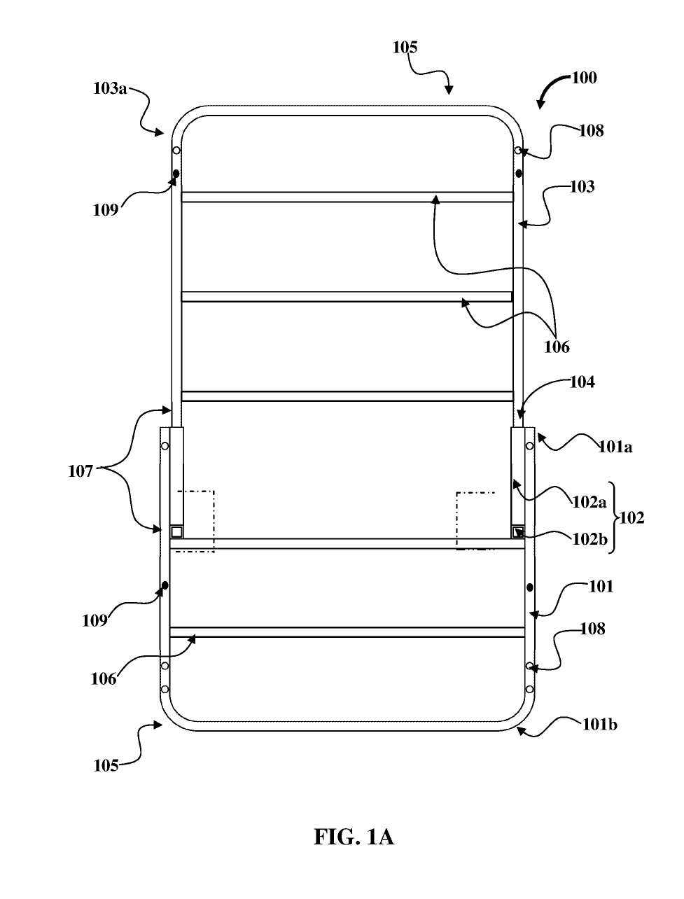

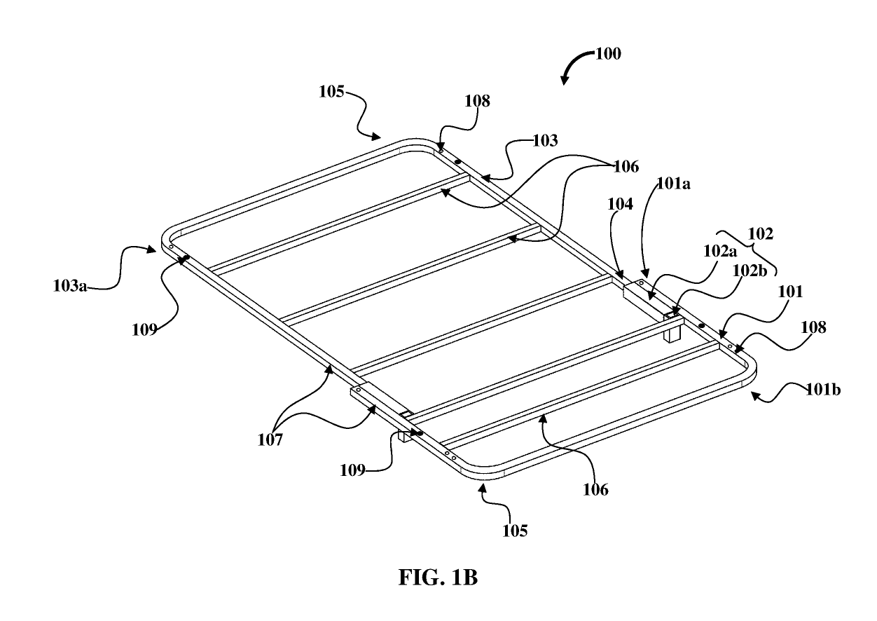

FIG. 1A exemplarily illustrates top plan view of a chair chassis 100 for a disassemblable chair, and FIG. 1B exemplarily illustrates a top perspective view of a chair chassis 100 for a disassemblable chair, showing the horizontal orientation of the seat member 101 and the backrest member 103. The chair chassis 100 for constructing a disassemblable chair comprises a seat member 101 and a backrest member 103. The seat member 101 is configured to provide a seat, where a rear section 101a of the seat member 101 comprises a first engagement member 102, and the backrest member 103 comprises a second engagement member 104, where the second engagement member 104 is engaged to the first engagement member 102 of the seat member 101 to removably connect the backrest member 103 to the seat member 101, where the backrest member 103 is selectively removable from the seat member 101. The seat member 101 and backrest member 103 is of, for example, ¾ inch tubing. Therefore, as shown in FIG. 1B, in a first embodiment, the backrest member 103 is engaged to a first 102a of the first engagement members 102 of the seat member 101, where the seat member 101 and the backrest member 103 are in a substantially horizontal position.

In an embodiment, the seat member 101 and the backrest member 103 are defined by a tubular framework. In an embodiment, the tubular framework defining the seat member 101 and the backrest member 103 comprises a generally U shaped tube member 105 with cross bars 106 extending across angled afts 107 of the U shaped tube member 105. The angled aft 107 is, for example, a 2 inch tube that supports the backrest member 103 when it is held in place. The angled aft 107 comprises corner brackets angled back at 13/16 inner diameter with 1 inch, for example, 1 inch tubing and 2 inch long. In an embodiment, the first engagement member 102 is a set of female connectors, and the second engagement member 104 is a set of male connectors, where both the male connectors and the female connectors are positioned on the angled afts 107 of the U shaped tube members 105 defining the framework of the seat member 101 and the backrest member 103.

In an embodiment, each male connector is inserted into the female connector to form a sliding fit connection between the seat member 101 and the backrest member 103. In an embodiment, the angled afts 107 of the seat member 101 and the backrest member 103 comprise openings 108 positioned proximal to the distal ends 101b and 103a of the seat member 101 and the backrest member 103, where the openings 108 are configured to receive and attach castor wheels. In an embodiment, the angled afts 107 of the seat member 101 and the backrest member 103 comprise holes 109 positioned on predefined points, wherein the holes 109 are configured to receive fasteners of cushion members which are configured to be attached on the tubular framework of the seat member 101 and the backrest member 103.

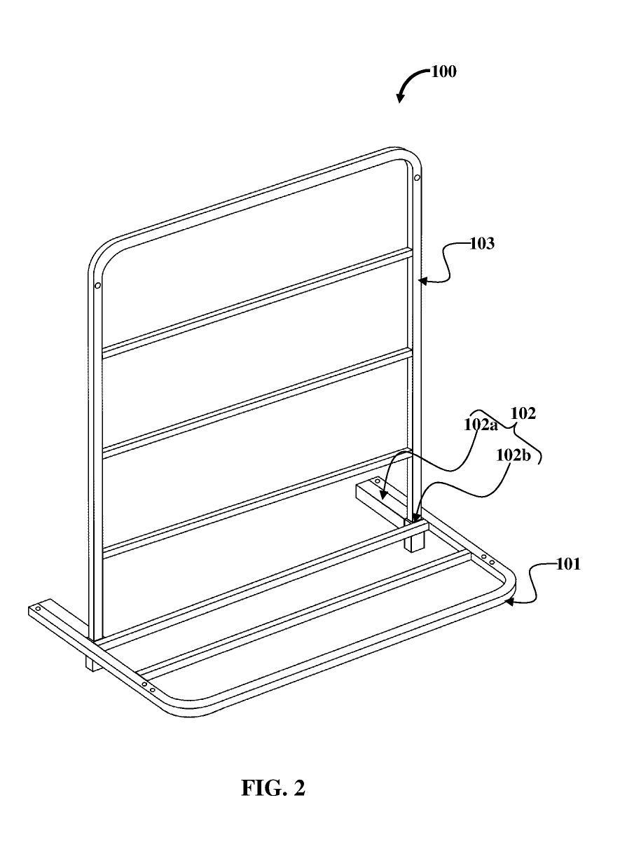

FIG. 2 exemplarily illustrates a top perspective view of a chair chassis 100 for a disassemblable chair, showing angled orientation of the seat member 101 and the backrest member 103. In second embodiment, the backrest member 103 is engaged to a second 102b of the first engagement members 102 of the seat member 101, wherein the seat member 101 and the backrest member 103 are in a substantially angled position. The chair chassis 100 disclosed herein is, for example, a knee board creeper used in tiling or hard wood floor installation with the back removed. The chair chassis 100 is configured to be positioned at floor level, as a full size creeper, or mini creeper with or without a backrest member 103 removed or disassembled. When the chair chassis 100 is in the mini creeper configuration, the chair chassis 100 is just half the size as compared to most of the conventional creeper assemblies and is a lot easier to maneuver without the extra 24 inches of the backrest member 103 as compared to the conventional creeper assemblies. The chair chassis 100 is not configured to fold, but the backrest member 103 is configured to be removable according to how the situation demands for a user and hence can stay in a low profile. In an example, the backrest member 103 also can be used as a seating arrangement according to the width and length of the seating arrangement required for a specified purpose of the user. In an example, the chair chassis 100 is configured to be split in half or even less the size. When converted to a seating configuration, the chair chassis 100 remains in close in contact with the floor. The conventional creeper assemblies are normal size creepers when in the down position, and when folded into a seat are several inches off the floor. The chair chassis 100 is, for example, about a 20-inch-wide, 18-inch-long frame with a 20 inch by 12-inch padded seat.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A chair chassis for constructing a disassemblable chair, comprising:
a seat member configured to provide a seat, wherein a rear section of the seat member comprises a set of first engagement members, wherein a first of the set of first engagement members and a second of the set of first engagement members are positioned perpendicular to one another;
a backrest member, wherein the backrest member comprises a second engagement member, wherein the second engagement member selectively engages the set of first engagement members of the seat member wherein the backrest member adjustable relative to the seat member between a first position and second position.

2. The chair chassis of claim 1, wherein the in the first position the backrest member is coplanar with the seat member.

3. The chair chassis of claim 1, wherein in the second position the backrest member is angled towards the seat member, wherein an angle between the backrest member and the seat member is less than 180 degrees.

4. The chair chassis of claim 1, wherein the seat member and the backrest member are defined by a tubular framework, wherein the second of the first set of engagement members are perpendicular to a plane of the seat member, wherein the second of the first set of engagement members extend downward from the seat member.

5. The chair chassis of claim 4, wherein tubular framework defining the seat member and the backrest member comprises a generally U shaped tube member with cross bars extending across angled afts of the U shaped tube member, wherein the tubular framework defining the seat member is continuous, and wherein the tubular framework defining the backrest member is continuous.

6. The chassis chassis of claim 5, wherein the set of first engagement members are a set of female connectors, and the second engagement member is a set of male connectors, wherein both the male connectors and the female connectors are position on the angled afts of the U shaped tube members defining the framework of the seat member and the backrest member.

7. The chair chassis of claim 6, wherein each male connectors slidingly engages the set of first engagement members.

8. The chair chassis of claim 1, further comprising a plurality of castor wheels, wherein one or more of the plurality of castor wheels is engaged to the backrest member, and one or more of the plurality of castor wheels is engaged to the seat member, wherein each of the plurality of castor wheels is engaged to the chair chassis on a same side.

9. The chair chassis of claim 8, further comprising one or more cushion members releasably attached to a plurality of fasteners, wherein each of the plurality of fasteners is engaged with a hole positioned on a side of the chair chassis opposite the plurality of castor wheels.
